(19) United States
(12) Patent Application Publication
(10) Pub. No.: US 2012/0169502 A1
(43) Pub. Date: Jul. 5, 2012

(54) ELECTRONIC BABY MONITORING DEVICE

(75) Inventors: REN-WEN HUANG, Shenzhen City (CN); JI-XIANG YIN, Shenzhen City (CN); JUN-WEI ZHANG, Shenzhen City (CN); JUN ZHANG, Shenzhen City (CN); TSUNG-JEN CHUANG, Tu-Cheng (TW); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/117,082

(22) Filed: May 26, 2011

(30) Foreign Application Priority Data
Dec. 31, 2010 (CN) 201010619608.4

(51) Int. Cl. G08B 23/00

(52) U.S. Cl. 340/573.1

(57) ABSTRACT

An electronic baby monitoring device includes a sensor monitor and a motion sensor. The motion sensor communicates with the sensor monitor and includes an accelerometer, a control module, an emitting module, a power source, and a switch. The accelerometer senses the acceleration value of the motion sensor. When the control module determines that at least two acceleration values sensed continuously by the accelerometer respectively reach or exceed a predetermined value, the control module turns on the switch to control the power source to provide power to the emitting module, generates control signals, and controls the emitting module to emit the control signals to the sensor monitor to direct the sensor monitor to take action.

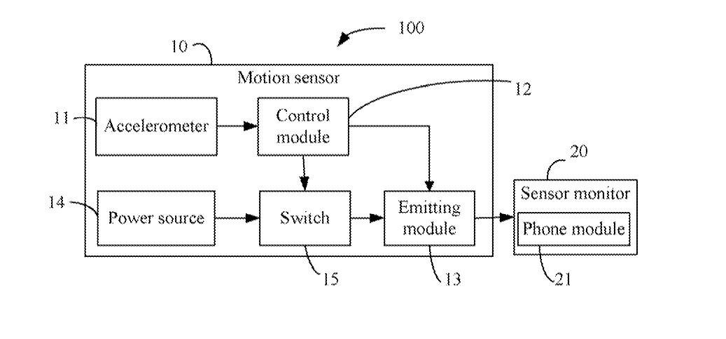

### BACKGROUND

1. Technical Field

The present disclosure relates to monitoring technology and, particularly, to an electronic device for monitoring a baby.

2. Description of Related Art

When a baby is sleeping comfortably, he/she will not move very much. However, when the baby is disturbed or uncomfortable, or about to wake up, he/she may fuss and make a lot of movement. Naturally, when a baby begins to fuss, the baby's parent or other caretaker would like to be aware of that, so they can take action. However, constant monitoring is difficult, many people may employ a device to help them. One kind of such devices uses an audio based walkie-talkie system. One problem with the current audio based monitor is that if the baby suffers from some problems that prevent the baby from crying out, such as being tangled up in bedding, the monitor will fail to be effective, and the baby's life may be in danger. Another problem is that if the environment is noisy then even if the baby cries out, he/she will not be heard. Therefore, what is needed is a baby monitor that does not depend on the volume of a baby's cries.

### BRIEF DESCRIPTION OF THE DRAWINGS

The components of the drawing are not necessarily drawn to scale, the emphasis instead being placed upon clearly illustrating the principles of an electronic baby monitoring device.

The drawing is a block diagram of an electronic baby monitoring device in accordance with an exemplary embodiment.

### DETAILED DESCRIPTION

The drawing is a block diagram of an embodiment of an electronic baby monitoring device 100. The device 100 includes a motion sensor 10 and a sensor monitor 20 in communication with the motion sensor 10. The motion sensor 10 may be positioned to sense movement of a baby's legs or arms. Such positioning can include directly attaching the motion sensor 10 to the baby with a strap or other means or simply by clipping the motion sensor 10 to a piece of clothing worn by the baby. The sensor monitor 20 is set in a location to communicate with the motion sensor 10. In this embodiment, the sensor monitor 20 is set in a location that provides line of site communication with the motion sensor 10 by, for example, infrared signaling. The sensor monitor 20 can be configured to communicate with other devices such as phones or computers. In this embodiment, the sensor monitor 20 includes a phone module 21 to communicate with a predetermined phone, and a phone number of the predetermined phone is programmed into the sensor monitor 20. In this embodiment, the sensor monitor 20 may call the phone number and send a predetermined message to the predetermined phone according to signals from the motion sensor 10. The predetermined phone may be carried by a caretaker of the baby. When the predetermined phone receives the message, the caretaker can take action to check the baby. In other embodiments, rather than using a message, just dialing the phone number may be used, and when the caretaker recognizes the number of the incoming call as being from the sensor monitor 20 he/she can take action. It should be noted that other communication means may be used, such as equipping the sensor monitor 20 with a BLUETOOTH module for communication with other devices via Internet such as smart phones or computers. The sensor monitor 10 may send a predetermined message to other devices via Internet. When the motion sensor 20 senses movement of the baby reaches or exceeds a predetermined range of motion in a predetermined amount of time, the motion sensor 10 sends signals to direct the sensor monitor 20 to take action, which in this case is sending a message to the caretaker's phone. The movement of the baby reaching or exceeding the predetermined range of motion in a short time indicates the baby's wakefulness and possible distress.

The motion sensor 10 includes an accelerometer 11, a control module 12, an emitting module 13, a power source 14, and a switch 15. In this embodiment, the power source 14 is connected to the emitting module 13 via the switch 15. The control module 12 selectively turns on or turns off the switch 15 to control the power source 14 to provide power to the emitting module 13. In this embodiment, when the switch 15 is turned on, the power source 14 can provide power to the emitting module 13. When the switch 15 is turned off, the power source 14 cannot provide power to the emitting module 13. In this embodiment, the emitting module 13 may be an infrared module.

The accelerometer 11 measures the acceleration value of the motion sensor 10. The accelerometer 11 may be a two-axis or three-axis accelerometer.

When the control module 12 determines that at least two acceleration values measured continuously by the accelerometer 11 respectively reach or exceed a predetermined value, the control module 12 turns on the switch 15 to control the power source 14 to provide power to the emitting module 13, generates control signals, and controls the emitting module 13 to emit the control signals to the sensor monitor 20 to direct the sensor monitor 20 to take action. The control module 12 further turns off the switch 15 after the emitting module 13 emits the control signals. The emitting module 13 is in a power on state only when the control module 12 determines to direct the sensor monitor 20 to take action, that is, only detecting that the baby may move a lot. Thus, the sensor monitor 20 produces less harmful radiations.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic baby monitoring device comprising:
a sensor monitor; and
a motion sensor communicating with the sensor monitor and comprising an accelerometer, a control module, an emitting module, a power source, and a switch, wherein, the accelerometer is to measure the acceleration value of the motion sensor, the emitting module is connected to the power source via the switch, the power source is capable of providing power to the emitting module when the switch is turned on, the control module is to turn on the switch to control the power source to provide power to the emitting module, generate control signals, and control the emitting module to emit the control signals to the sensor monitor when the control module determines that at least two acceleration values measured continuously by the accelerometer respectively reach or exceed a predetermined value;
the sensor monitor to take action according to the control signals from the motion sensor.

2. The electronic baby monitoring device as described in claim 1, wherein the control module is further to turn off the switch after controlling the emitting module to emit the control signals.

3. The electronic baby monitoring device as described in claim 1, wherein the sensor monitor comprises a phone module to communicate with a predetermined phone, a phone number of the predetermined phone is programmed into the motion sensor, the action the sensor monitor to take is that the sensor monitor calls the phone number and sends a predetermined message to the predetermined phone.

4. The electronic baby monitoring device as described in claim 1, wherein the sensor monitor comprises a phone module to communicate with a predetermined phone, a phone number of the predetermined phone is programmed into the motion sensor, the action the sensor monitor to take is that the sensor monitor dials the phone number.

5. The electronic baby monitoring device as described in claim 1, wherein the sensor monitor comprises a communication module communicating with external devices via Internet, the action the sensor monitor to take is that the sensor monitor sends a predetermined message to the external devices via Internet.

6. The electronic baby monitoring device as described in claim 1, wherein the accelerometer is a two-axis sensor.

7. The electronic baby monitoring device as described in claim 1, wherein the accelerometer is a three-axis sensor.
